(19) United States
(12) Patent Application Publication
(10) Pub. No.: US 2017/0052146 A1
(43) Pub. Date: Feb. 23, 2017

(54) METHODS AND APPARATUS FOR INTRODUCING A SAMPLE INTO A SEPARATION CHANNEL FOR ELECTROPHORESIS

(71) Applicant: University of Southampton, Southampton (GB)

(72) Inventors: Xize Niu, London (GB); Sammer-ul Hassan, Southampton (GB)

(21) Appl. No.: 15/306,997

(22) PCT Filed: Apr. 28, 2015
(86) PCT No.: PCT/GB2015/051234

§ 371 Date: Oct. 26, 2016

(30) Foreign Application Priority Data
Apr. 30, 2014 (GB) 1407601.2

(51) Int. Cl. G01N 27/447; B01L 3/00

(52) U.S. Cl. CPC G01N 27/44743; G01N 27/44791; B01L 3/502784; B01L 2400/0421; B01L 2200/0673; B01L 2300/161; B01L 2200/025

(57) ABSTRACT

Methods and apparatus for introducing a sample into a separation channel for electrophoresis are disclosed. In one arrangement sample droplets having a membrane that encapsulates a sample are formed and brought to an injection position in contact with a transport medium of a separation channel. An electric field is applied to rupture the sample droplets and cause the sample to enter the separation channel and undergo electrophoresis.

The present invention relates to methods and apparatus for introducing a sample into a separation channel for electrophoresis.

Electrophoresis is one of the most powerful and widely used tools in separation science and has been elaborated significantly since its introduction. For example, capillary gel electrophoresis (CGE) has played an essential role in genome sequencing and 2D polyacrylamide gel electrophoresis is still considered the gold-standard in separating complex mixtures of proteins. In recent years both capillary and chip based electrophoresis techniques have been used to provide for automated and high-throughput analysis in the fields of genomics, proteomics, metabolomics, enzyme analysis and cellomics. Such methods include capillary zone electrophoresis (CZE), capillary gel electrophoresis (CGE), micellar electrokinetic chromatography (MEKC), capillary isoelectric focusing (CIEF) and capillary isotachophoresis (CITP).

Chip-based and capillary-based methods are notable for their ability to deal with small volumes, to provide for high separation efficiencies and component resolution and to be easily automated and coupled with downstream methodologies, such as liquid chromatography and mass spectrometry. Whilst there have been extensive studies on separation conditions, surface chemistries and surface modifications, methods currently used for sample injection vary little from original formats proposed twenty years ago. Specifically, the two primary injection methods used in both capillary and chip-based electrophoresis are based on electrokinetic and hydrostatic injection. When using electrokinetic injection, biases arise at the injection point since analyte molecules have different electrophoretic mobilities. Accordingly, the absolute number of injected molecules often does not reflect the analytical concentration in the original sample. Hydrostatic injections are not biased in this manner, but conversely suffer from a lack of control with respect to the volume delivered during the injection, and the overall throughput of the device. It should also be noted that although the injection zones in CE/MCE tend to be less than 10 nL, the actual sample needed for performing a separation is significantly higher. As a consequence, the majority of the sample is not analyzed, and thus traditional CE/MCE methods are not suited to the analysis of rare analytes within samples without dilution. Indeed, operational modifications are often needed when, for example, performing electrophoretic single cell analysis.

In recent years, droplet-based microfluidic systems have been increasingly popular due to a range of potential applications and performance advantages. Segmented flows formed within microfluidic channels have been shown to be powerful tools for encapsulating small molecules, biomolecules, cells and organisms into sub-nL volumes. To this end there have been a number of recent studies that have utilized droplets as a unique tool in transferring sub-nL volume samples to and from traditional capillary or microfluidic chips. Various methods have been developed with the aim of achieving precise and controllable injection of droplets to electrophoretic separation columns in a reproducible manner. For example, sample droplets can be directly injected (using a carrier oil) into a separation channel, or via controlled fusion by surface treatments or hydrodynamic interactions. However, these approaches generally require complex apparatus or methods to achieve precise and reproducible control.

It is an object of the invention to provide simpler and/or more reliable methods and apparatus for introducing droplets into an electrophoresis device.

According to an aspect of the invention, there is provided a method of introducing a sample into a separation channel for electrophoresis, comprising: encapsulating the sample within a sample droplet, the sample droplet having a spatially continuous sample droplet membrane that surrounds the sample within the sample droplet; bringing the sample droplet to an injection position in which a first region of the sample droplet membrane is in contact with a portion of a first surface and a second region of the sample droplet membrane, different from the first region, is in contact with a portion of a second surface, wherein: the first and second surfaces are configured so that the material forming the sample droplet membrane will not pass through the surfaces and is capable of stably isolating the sample from the first and second surfaces while the droplet is intact; the method further comprises applying an electric field to the sample droplet via the first and second surfaces, the electric field being such as to cause the sample droplet membrane to rupture and the sample to be brought into contact with the first and second surfaces; and the second surface is a surface of a transport medium defining the separation channel, the transport medium being configured such that the sample passes through the second surface and into the separation channel when the sample droplet membrane is ruptured.

Thus, a method is provided in which a sample can be injected efficiently and reliably into a separation channel for electrophoresis. The approach allows use of samples encapsulated within droplets without complex apparatus. The use of droplets minimizes loss of sample (so that rare analytes can be analysed effectively for example) and facilitates high throughput. Biasing in the composition of an injected sample, which can arise as discussed above when only a portion of a sample is injected, for example using electrokinetic injection, does not arise as substantially all of contents of the droplet and therefore all of the sample is injected.

The droplets are injected reliably by conveying them to a position at which they contact one or two surfaces (“first” and “second” surfaces, which may form two separate surfaces or may represent different portions of a single surface) and using an applied electric field to rupture the droplet and bring the sample into contact with the one or two surfaces and therefore the separation channel. The technique can be implemented using simple and compact apparatus that can be miniaturized efficiently and interfaced with other devices for manipulation and testing of the droplets.

In an embodiment, the first and second surfaces define opposite surfaces of an elongate channel and the sample droplet is brought to the injection position by conveying the sample droplet along the elongate channel. In arrangements of this type the transport medium therefore acts both to define walls of a channel to transport the sample to an injection position (prior to injection) and as the matrix within which the electrophoretic separation of the sample is achieved (after injection). This arrangement simultaneously provides advantages of both gel and capillary electrophoresis arrangements. For example, after rupture of the droplets and injection of the sample into the transport medium, the apparatus can be operated in a similar way as a normal gel electrophoresis arrangement: the sample constituents can be stacked, separated, stained, visualized and quantified, or post processed with Western blot or mass spectrometry. At the same time, the apparatus can be miniaturized in a similar way to existing capillary-based techniques and interfaced with other capillary-based devices. Automatic sample loading, high throughput and/or ultra-small sample consumption are also facilitated.

The constraining of the sample within the elongate channel, which can easily be made very narrow in the direction parallel to the direction of electrophoretic separation, facilitates high separation resolution because the spatial spread of the sample at the point of injection is minimized. The channel width can for example be as small as 100˜200 μm. Furthermore, high separation resolution is further facilitated by less heat generation and faster heat dissipation because of shorter separation lengths and the fact that the transport medium can be made very thin (which also leads to shorter staining and de-staining times).

In an embodiment, the sample droplet is formed in between opposing faces of first and second substrates that are slidably engaged against one another; and the sample droplet is brought to the injection position by sliding the first and second substrates relative to each other from a first position to a second position. This approach provides a convenient and reliable way of introducing droplets to a separation channel formed for example as a capillary in a microfluidic chip. The arrangement does not necessarily require a separate apparatus to form the droplets. The arrangement can easily be adapted simultaneously to form a plurality of droplets and inject those droplets into a plurality of parallel separation channels in the same microfluidic chip.

According to an alternative aspect of the invention, there is provided an apparatus for introducing a sample into a separation channel for electrophoresis, comprising: the separation channel, wherein the separation channel comprises a transport medium; a conveyance unit configured to bring a sample encapsulated within a sample droplet, the sample droplet having a spatially continuous sample droplet membrane that surrounds the sample within the sample droplet, to an injection position in which a first region of the sample droplet membrane is in contact with a portion of a first surface and a second region of the sample droplet membrane, different from the first region, is in contact with a portion of a second surface, wherein: the first and second surfaces are configured so that the material forming the sample droplet membrane will not pass through the surfaces and is capable of stably isolating the sample from the first and second surfaces while the droplet is intact; the apparatus further comprises an electrophoresis driving unit configured to apply an electric field to the sample droplet via the first and second surfaces, the electric field being such as to cause the sample droplet membrane to rupture and the sample to be brought into contact with the first and second surfaces; and the second surface is a surface of the transport medium of the separation channel, the transport medium being configured such that the sample passes through the second surface and into the separation channel when the sample droplet membrane is ruptured.

According to an alternative aspect of the invention, there is provided a method of introducing a sample into a separation channel for electrophoresis, comprising: forming a sample droplet between first and second substrates that are slidably engaged against one another; bringing the sample droplet to an injection position in which the sample droplet is in contact with a transport medium in the separation channel by sliding the first and second substrates relative to each other from a first position to a second position; and applying an electric field to the sample droplet via the transport medium.

Thus, a method is provided which allows droplets to be formed conveniently and simply, without requiring complex fluid management or pumping systems. Furthermore, the droplets are formed in close proximity to the injection position, minimizing risk of droplet spread or loss prior to injection.

According to an alternative aspect of the invention, there is provided an apparatus for introducing a sample into a separation channel for electrophoresis, comprising: the separation channel, wherein the separation channel comprises a transport medium; a conveyance unit configured to bring a sample droplet to an injection position in which the sample droplet is in contact with the transport medium of the separation channel; an electrophoresis driving unit configured to apply an electric field to the sample droplet via the transport medium; and first and second substrates that are slidably engagable against one another and configured such that the sample droplet can be formed between opposing faces thereof when the first and second substrates are thus engaged, wherein the first and second substrates are configured such that the sample droplet can be brought to the injection position by sliding the first and second substrates relative to each other from a first position to a second position.

Embodiments can be applied in the following contexts:

High throughput Parallel separations for separating: peptides, proteins, nucleic acids (DNA, RNA, or oligonucleotides), genomics, biomarkers, drug discovery, etc.

Proteomics: blood serum electrophoresis, 2-D separation i.e. isoelectric focusing in one direction and electrophoresis in second direction, saliva proteins, sodium dodecyl sulfate polyacrylamide gel electrophoresis, native protein electrophoresis, western blotting, eastern blotting.

Nucleic acid and PCR: DNA sizing, forensics, diseases related to nucleic acids, PCR studies.

Electrophoretic Immunoassays and Biomarkers discovery: enzymes, hormones, drug analytes, cancer biomarkers, stress hormones such as cortisol, insulin secretion, biomarker discovery from biofluids such as saliva, tears, urine, blood.

Pharmaceutics: drug discovery, metabolomics, kinetic studies of drugs, quality control of drugs.

Environmental studies: monitoring of chemicals such as ions, toxics, pathogens or the other biomolecules from environment and quantification of hazardous materials.

Point-of-care (POC) Diagnostics: healthcare monitoring, rapid quantification of biomarkers such as early detection of cancers in blood, easy to operate and user friendly devices for Lithium ion and sodium concentration blood, eyes infections and saliva electrophoresis, appropriate and prompt test for immediate treatments, cardiovascular diseases, respiratory diseases, neuropsychiatric diseases, infection diseases such as malaria, tuberculosis, HIV/AIDS, diarrheal disease and lower respiratory infections etc.

Embodiments of the invention will now be described, by way of example only, with reference to the accompanying drawings in which corresponding reference symbols indicate corresponding parts, and in which:

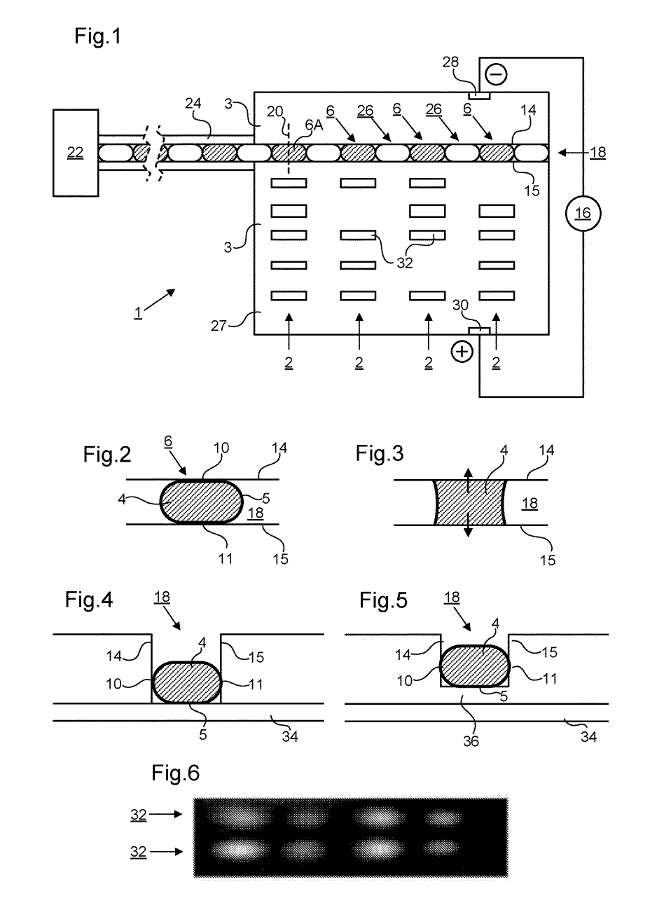

FIG. 1 depicts an apparatus for introducing a sample into a separation channel for electrophoresis according to a first exemplary embodiment;

FIG. 2 is a schematic top view of an intact sample droplet in an elongate channel of the arrangement of FIG. 1;

FIG. 3 is a schematic top view of the sample droplet shown in FIG. 2 after rupture by an electric field;

FIG. 4 depicts a cross-sectional profile of an example elongate channel;

FIG. 5 depicts a cross-sectional profile of an alternative example elongate channel;

FIG. 6 depicts an image showing electrophoretic separation of molecules using an arrangement of the type illustrated in FIG. 1;

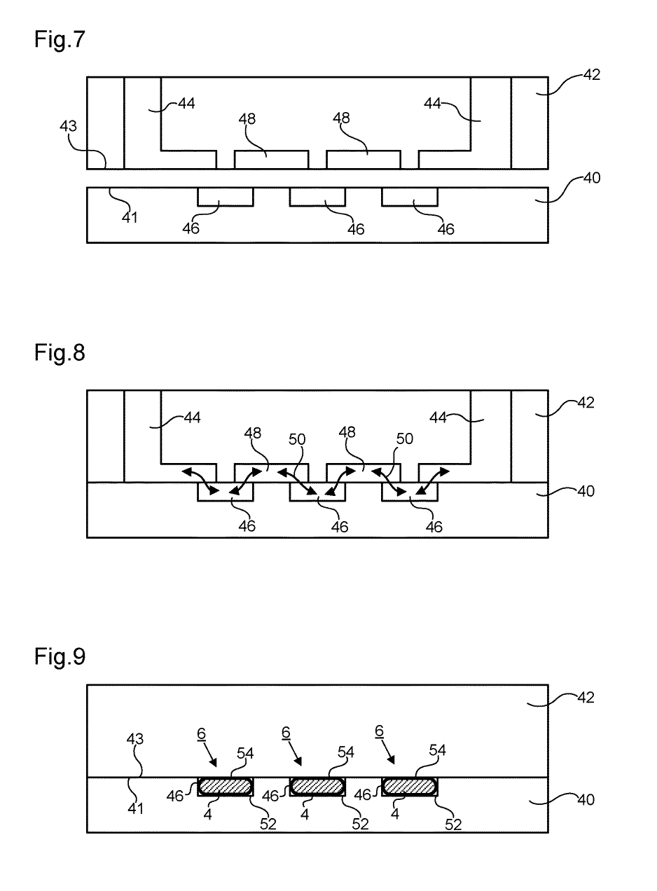

FIG. 7 depicts an end view of an apparatus for introducing a sample into a separation channel for electrophoresis according to a second exemplary embodiment with first and second substrates in a separated state;

FIG. 8 depicts an end view of the apparatus of FIG. 7 after the first and second substrate have been brought into a state of slidable engagement with each other;

FIG. 9 depicts an end view of the apparatus of FIG. 8 after the first and second substrates have been slid (“slipped”) into a “first position”, defined as a position at which droplets are encapsulated;

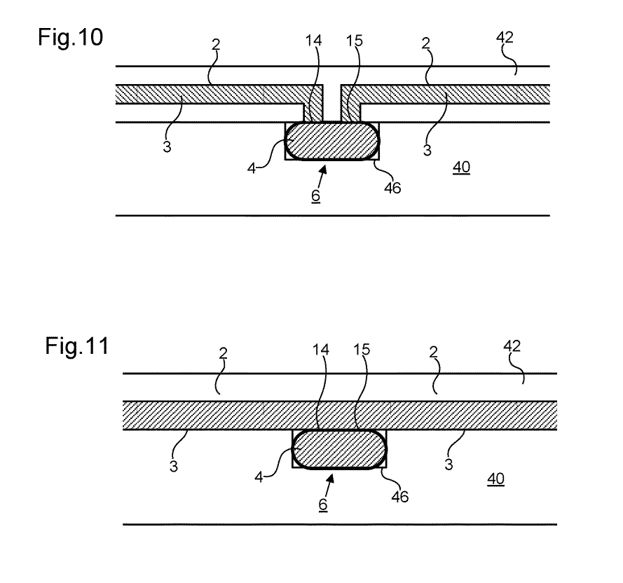

FIG. 10 depicts a side view of the apparatus of FIG. 9 after the first and second substrates have been slid (“slipped”) from the first position to a “second position”, defined as a position at which droplets can be injected into a separation channel on application of an electric field;

FIG. 11 depicts an alternative to the arrangement of FIG. 10, in which the sample droplet 6 is brought into contact with a continuous separation channel;

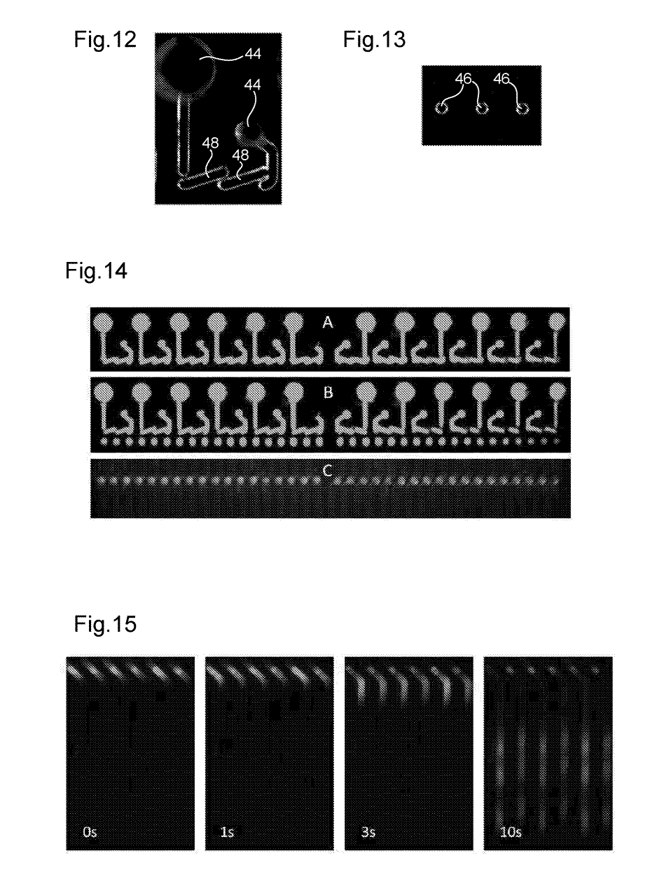

FIG. 12 is a microscopic photographic top view of an example configuration for sample reservoirs and indentations in a “second substrate”;

FIG. 13 is a microscopic top view of an example configuration for indentations in a “first substrate” compatible with the arrangement of FIG. 12;

FIG. 14A-C are microscopic photographic top views of sample moving through an apparatus comprising multiple instances of the reservoirs and indentations shown in FIGS. 12 and 13;

FIG. 15 are microscopic photographic top views of the separation channels of the apparatus of FIGS. 14A-C after injection of droplets into separation channels (as shown in FIG. 14C);

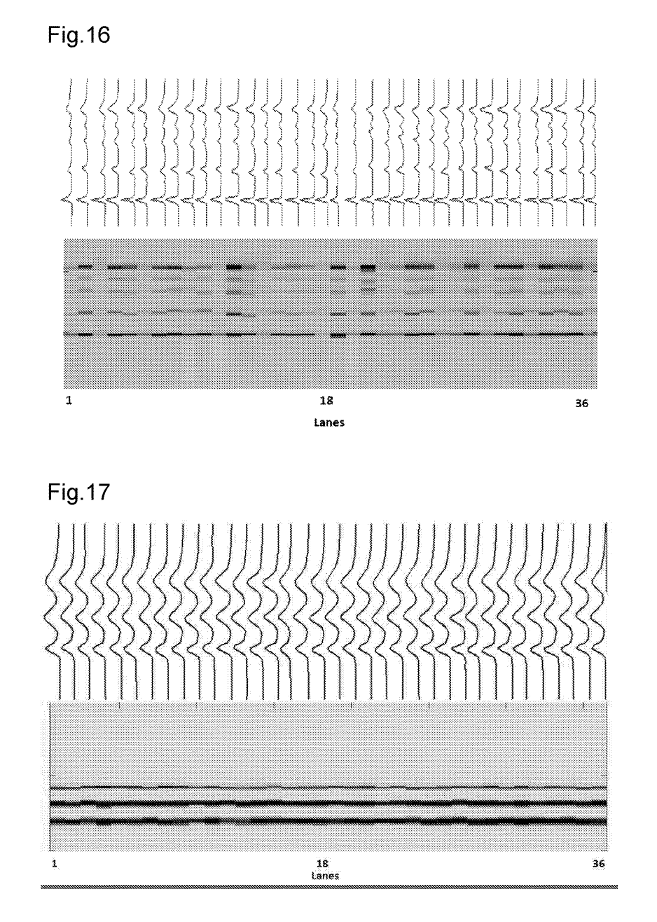

FIG. 16 depicts example electropherograms of five different fluorescent molecules separated in an apparatus of the type shown in FIGS. 12-15;

FIG. 17 depicts example electropherograms of three different fluorescent molecules separated in an apparatus of the type shown in FIGS. 12-15;

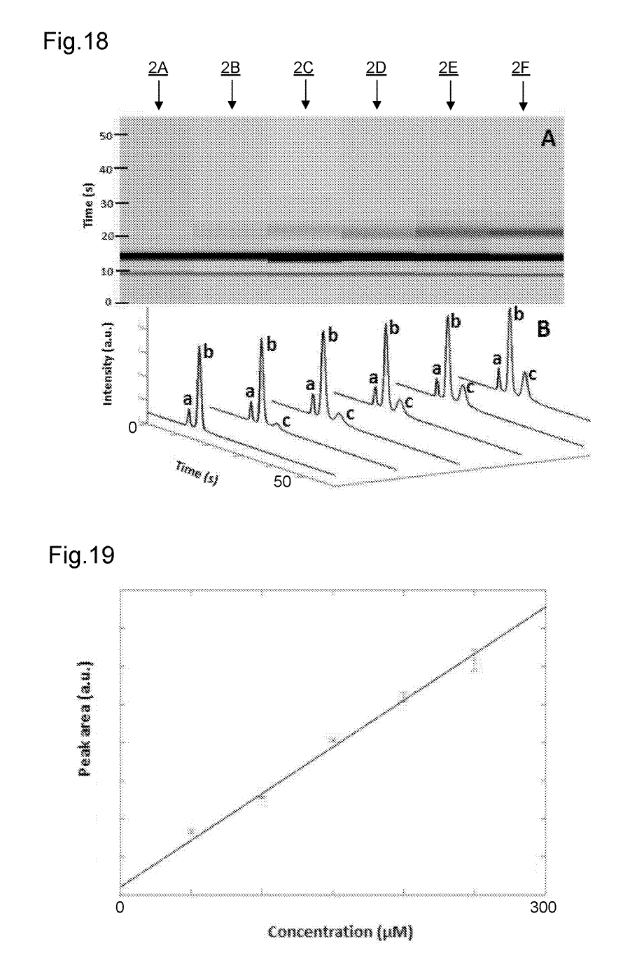

FIGS. 18A and 18B depict electropherograms used for concentration calibration;

FIG. 19 shows example results of concentration calibration.

An apparatus 1 is provided for introducing a sample into a separation channel for electrophoresis. A first exemplary embodiment of the apparatus 1 is described in further detail below with reference to FIGS. 1-6. A second exemplary embodiment of the apparatus 1 is described in further detail below with reference to 7-19.

### Features Common to First and Second Exemplary Embodiments

The separation channel 2 comprises a transport medium 3. The transport medium 3 allows movement of constituents of the sample through it on application of an electric field during electrophoresis.

A sample 4 is provided to the separation channel 2 encapsulated within a sample droplet 6. The sample droplet 6 has a spatially continuous sample droplet membrane 5 that surrounds (completely encloses) the sample within the sample droplet. The sample is therefore isolated from the external environment while in the droplet state by the membrane 5.

A conveyance unit is provided that is configured to bring the sample droplet 6 to an injection position. In the injection position, a first region 10 of the sample droplet membrane 5 is in contact with a portion of a first surface 14 and a second region 11 of the sample droplet membrane 5, different from the first region 10, is in contact with a portion of a second surface 15. The first and second surfaces 14 and 15 are configured so that the material forming the sample droplet membrane 5 will not pass through the surfaces 14 and 15. The sample droplet membrane 5 isolates the sample from the first and second surfaces 14 and 15. The first and second surfaces 14 and 15 may be separated from each other or contiguous.

The apparatus 1 further comprises an electrophoresis driving unit 16. The electrophoresis driving unit 16 is configured to apply an electric field to the sample droplet 6 via the first and second surfaces 14 and 15. The electric field causes the sample droplet membrane 5 to rupture and the sample to be brought into contact with the first and second surfaces 14 and 15. The second surface 15 is a surface of the transport medium 3 of the separation channel 2. The transport medium 3 is configured such that the sample passes through the second surface 15 and into the separation channel 2 when the sample droplet membrane 5 is ruptured. In an embodiment, the first surface 14 is also a surface of a transport medium 3 but this is not essential.

The sample droplet membrane 5 may be formed using a surfactant. For example, where the sample comprises an aqueous solution the surfactant may comprise amphiphilic molecules.

The second surface 15 is generally configured so as to repel the exterior of the sample droplet membrane 5 and attract the interior of the sample droplet (the sample). For example, when the sample comprises an aqueous solution the second surface 15 may be hydrophilic. Conversely, where the sample comprises hydrophobic material (e.g. a non-aqueous solution or oleophilic material) the second surface may be arranged to be hydrophobic.

In an embodiment, the first and second surfaces are electrically isolated from each other in the absence of any sample droplet 6 connecting any portion of the first and second surfaces 14 and 15 together. For example, the electrical resistance between the first and second surfaces 14 and 15 may be many times higher in the absence of any droplet than where a droplet is provided (e.g. greater than 100 times or greater than 1000 times).

### FIRST EXEMPLARY EMBODIMENT

FIG. 1 discloses an apparatus 1 according to a first exemplary embodiment. In this embodiment, the first and second surfaces 14 and 15 define opposite surfaces of an elongate channel 18. The apparatus 1 is configured so that the sample droplet 6 can be brought to the injection position by conveying the sample droplet 6 along the elongate channel 18. The elongate channel 18 and/or apparatus for conveying the droplets along it may therefore be considered as a “conveyance unit”. In this example, the injection position is defined for a particular sample droplet 6 as the position in the elongate channel 18 at which the electric field is applied and the sample droplet 6 ruptures. For example, for the sample droplet marked 6A the injection position is marked 20. Where a plurality of sample droplets 6 are present in the elongate channel 18 simultaneously there may be a plurality of injection positions at different longitudinal positions along the elongate channel 18 (one for each sample droplet).

The elongate channel 18 may be configured to allow a stream comprising a plurality of the sample droplets 6 to be conveyed into the elongate channel 18. For example, the elongate channel 18 may be formed so as to be significantly longer than a practically achievable and useful longitudinal length of sample droplet. In the schematic example shown four sample droplets 6 are present in the elongate channel 18. In other embodiments, fewer than four or more than four may be achieved. Providing a plurality of sample droplets 6 in the elongate channel 18 makes it possible to perform electrophoresis on a plurality of different sample droplets 6 at the same time.

The apparatus 1 may further comprise a droplet generation device 22 for providing the sample droplets 6. The droplet generation device 22 may supply the generated droplets to the elongate channel 18 via an input conduit 24. The droplet generation device 22 may be configured to provide a stream comprising a plurality of the sample droplets 6 (as in the example shown). The stream may comprise a surfactant to prevent any unwanted droplet-droplet or droplet-transport medium (gel) merging. The surfactant therefore facilitates reliable transfer of the droplet stream from the droplet generation device, maintaining the integrity and time sequence of the droplets 6.

In an embodiment, the droplet generation device 22 is configured to provide one or more reference droplets in between adjacent sample droplets 6 in the stream. The reference droplets 26 may be used to calibrate size and/or concentration for example. The reference droplets may contain a lactate standard for example.

Other sequences of droplets are possible. For example the sample droplets 6 may be adjacent to other sample droplets 6, to gas (e.g. air) bubbles, or to other buffer droplets.

In an embodiment, the electrophoresis driving unit 22 is configured to apply an electric field that extends at least from the first surface 14 through the second surface 15 to a distal region 27 within the transport medium 3. In the example shown the elongate channel 18 is bordered on both sides by the transport medium 3 and the electrical field is applied via a connection 28 to a first portion of the transport medium 3 on one side of the elongate channel 18 and via a connection 30 to a second portion of the transport medium 3 on the other side of elongate channel 18. The region adjacent to the connection 30 may therefore be considered to correspond to the distal region 28 in this embodiment. A side of the first portion of the transport medium 3 that faces into the elongate channel 18 corresponds to the first surface 14. A side of the second portion of the transport medium 3 that faces into the elongate channel 18 corresponds to the second surface 15. Exemplary polarities are shown. The applied electric field is such as (e.g. sufficiently large) to cause simultaneous rupture of the sample droplet membranes 5 of a plurality of sample droplets 6 in the elongate channel 18. The samples 4 from the ruptured droplets 6 pass through the second surface 15 and undergo electrophoresis in parallel directions within the transport medium 3 between the second surface 15 and the distal region 28. In the orientation of FIG. 1 the electrophoresis involves a downward movement of the samples 4. The four vertically aligned series of boxes 32, aligned with each of the four sample droplets 6 in the channel 18 illustrate schematically the electrophoretic separation process. An integral body of the transport medium 3 forms all of the separation channels 2 in this embodiment, without any walls or other separations between the channels. This is not essential but does simplify manufacture relative to arrangements in which each individual separation channel has its own walls (e.g. as in a capillary-based arrangement).

The rupturing process is illustrated schematically in FIGS. 2 and 3, which are schematic top views of an intact sample droplet 6 (FIG. 2) and a ruptured sample droplet (FIG. 3). In FIG. 2 it can be seen that the sample droplet membrane 5 is concave and does not wet the walls of the elongate channel 18 to a great extent due to the relatively large surface tension (surface energy per unit area) associated with the interface between the membrane 5 and the first and second surfaces 14 and 15. The sample droplet 6 is thus intact and contains the sample 4. Neither the membrane 5 nor the sample 4 can move into the transport medium 3 in this state. The membrane 5 separates the sample 4 from the transport medium 3. FIG. 3 on the other hand represents the situation after the electrical field has been applied. The inventors have found that the electrical field disrupts the stable droplet shape and leads to the sample 4 being brought into contact with the first and second surface 14 and 15. The sample 4 wets the first and second surfaces and penetrates effectively into the transport medium 3. The sample molecules move out electrophoretically from the droplets 6 into the transport medium 3 and are separated based on their size and charge, as in a standard electrophoresis process.

The cross-sectional shape of the elongate channel 18 can take various forms. FIGS. 4 and 5 show two examples. In these examples, the elongate channel 18 is bounded on lateral sides by the first and second surfaces 14 and 15, and is open on a third side (upwards in the orientation of the figures). In FIG. 4, the transport media 3 positioned on opposite sides of the elongate channel are mounted on a common substrate 34 but are completely separated from each other. A base portion of the channel 18 is formed by a surface of the common substrate 34. However, this is not essential. FIG. 5 depicts an alternative arrangement in which a base portion of the channel 18 (lower portion in the orientation of the figures) is formed by a strip 36 of the transport medium 3. The strip 36 is shallower than the transport medium 3 provided on opposite sides of the first and second surfaces 14 and 15. The arrangement of FIG. 4 may be advantageous because the surface properties of the base of the channel 18 can easily be made different to the surface properties of the first and second surfaces 14 and 15. The base can therefore be designed to achieve optimal injection of the sample through the second surface 15, with a minimum spatial lag between different portions of the sample and/or with a minimum risk of portions of the sample being left behind in the channel 18. For example the surface tension of the base with respect to the sample 4 can be made high (such that the sample is repelled from the base—e.g. hydrophobic for hydrophilic/aqueous samples).

In an embodiment the transport medium 3 is a gel. The gel may be a pre-cured gel for example. The gel may comprise Agarose gel, polyetherimide gel, gradient gel, etc. In the above embodiments the transport medium 3 is shown mounted on a single substrate 34, such that the channel 18 is open on one side (the upper side as shown). However, this not essential. In other embodiment the transport medium 3 is a buffer (TBE, PEO, . . . etc.). In other embodiments the transport medium may be sandwiched between two substrates 34 such that the channel 18 is closed. The substrates 34 may be formed from a glass for example.

In an embodiment, the thickness of the combination of transport medium and, where provided, substrate or substrates 34 is in the region of about 100˜200 μm. In an embodiment, the width of the elongate channel 18 (in the direction of electrophoretic separation) is also in the range of about 100˜200 μm.

Various methods can be used to form the channel 18, such as moulding, machining, photo initiated gel, etc.

FIG. 6 is in image illustrating use of an apparatus 1 according to an embodiment of this type comprising Agarose gel as the transport medium 3 sandwiched between two piece of glass. Fluorescent molecules (fluorescein and FITC) in the droplets are seen to separate within one minute.

Analyses using the apparatus 1 can be extended in various ways. For example, subsequent to carrying out the separation in the channels 2 components of the separated samples may themselves be collected and subjected to further analyses (e.g. separations using other techniques, such as mass spectrometry, western blotting or other immunoassays. The platform can also be combined with electrowetting-on-dielectric (EWOD) for further droplet manipulations for example.

### SECOND EXEMPLARY EMBODIMENT

FIGS. 7-11 are schematic views of an apparatus 1 according to a second exemplary embodiment. The apparatus 1 comprises a first substrate 40 and a second substrates 42. The first and second substrates 40 and 42 are slidably engagable against one another. The substrates 40,42 may for example take a substantially planar form having substantially flat opposing faces 41 and 43 (e.g. faces that are flat over a large proportion or a majority of their surface, deviating from flatness for example only where indentations or other structures are machined or otherwise formed in their surfaces) that are brought into contact with each other in order to provide the slidable engagement.

The first and second substrates 40 and 42 are configured such that the sample droplet 6 can be formed or positioned between opposing faces 41 and 43 thereof when the first and second substrates 40 and 42 are in slidable engagement.

FIGS. 7-9 illustrate an example droplet formation process.

In an embodiment, the first and second substrates 40 and 42 are configured such that the sample droplet can be formed by: 1) introducing a liquid sample to one or more reservoirs 44 formed in one or both of the first and second substrates 40 and 42; and 2) positioning the first and second substrates 40 and 42 such that an indentation 46 in the first substrate 40 (for holding the sample droplet 6 when the first and second substrates 40 and 42 are in a “first position” as discussed below) overlaps with an indentation 48 in the second substrate 42 that on its own or in combination with other indentations 48 in either or both of the first and second substrates 40,42, provides a continuous flow path (arrows 50) to one or more of the reservoirs 44. The indentations 46 and 48 may take various forms and be manufacturing in various ways (e.g. moulding, etching, cutting, etc.).

FIG. 7 is an end sectional view of the apparatus 1 in a disassembled state, with the first and second substrates 40 and 42 separated from each other in a direction perpendicular to the plane of the substrates 40, 42. The sectional plane cuts through example reservoirs 44, and the indentations 46 and 48. FIG. 8 shows the arrangement of FIG. 7 after the first and second substrate 40 and 42 have been brought into a state of slidable engagement. A composition, comprising for example a surfactant, for forming sample droplet membranes 5 may be provided to one or both of the opposing surfaces 41 and 43 prior to their being brought together. Alternatively or additionally, the composition for forming sample droplet membranes 5 may be added to one or more of the reservoirs 44, for example at the same time as the sample is added to the reservoirs.

The surface of the two substrates may be rendered hydrophobic by various surface coatings, such as parylene, PTFE or any other materials or particles having a hydrophobic end. Alternatively, the substrate may be made from a hydrophobic material. Such coatings or materials can prevent the sample droplets being damaged and/or leakage of the contents from the droplets.

After the sample and the composition for forming the sample droplet membrane has been provided to the indentations 46, using for example the first and second substrates 40 and 42 positioned as shown in FIG. 8, the first and second substrates can be slid or “slipped” relative to each other to move them to a relative position at which at least one sample droplet 6 is provided in an isolated form (i.e. not in fluid communication with any other droplet or reservoir). This relative position is an example of the “first position” mentioned above. In this first position the sample droplet 6 is contained within a closed cavity 52 formed by an indentation 46 within the first substrate 40 and a portion 54 of the opposing surface 43 of the second substrate 42 (which may or may not comprise an indentation that overlaps with the indentation 46). FIG. 9 depicts an example of the first and second substrates 40 and 42 being in the first position. In this example the portion 54 of the opposing surface 43 that closes the cavity 52 is a flat, featureless portion of the opposing surface 43, but this is not essential. The first position may be achieved by providing relative sliding between the first and second substrates 40 and 42 in a direction perpendicularly into or out of the page in FIG. 8. Sample droplets 6 comprising sample 4 encapsulated by sample droplet membrane 5 are formed in each of the closed cavities 52. Three closed cavities are shown in the example but many more may be provided.

The first and second substrates 40 and 42 are further configured such that the sample droplet 6 can be brought to the injection position by sliding the first and second substrates 40 and 42 from the first position to a second position. The first and second substrates 40 and 42 may therefore be considered as an example “conveyance unit”. FIGS. 10 and 11 show magnified side views of a single droplet in the arrangement of FIG. 9 after the substrates have been slid into the second position. The view of FIGS. 10 and 11 are perpendicular to the views of FIGS. 7-9 (i.e. FIGS. 7-9 can be referred to as “end views” and FIGS. 10 and 11 as “side views”).

The sample droplets 6 may be generated and transported to the injection position in other ways. For example, sample droplets 6 may be generated in situ from a cell culture reservoir. Isoelectric focussing (IEF) may be used, as described for example in “Droplet-based in situ compartmentalization of chemically separated components after isoelectric focusing in a Slipchip”, Yan Zhao et al, Lab Chip, 2014, 14, 555-561. Alternatively, sample droplets may be generated outside of the first and second substrates and conveyed to the injection position as a stream of droplets in the same way as the droplets are conveyed to the injection elongate channel 18 in the first exemplary embodiment.

In the second position the indentation 46 is in a position that is opposite to a first opening providing access to the first surface 14 and a second opening providing access to the second surface 15. In this embodiment the transport medium 3 defining the separation channel 2 is formed within the second substrate 42. As in the first exemplary embodiment, application of an electric field across the droplet 6 via the first and second surfaces 14 and 15 causes rupturing of the droplet 6, with the result that the sample 4 can enter the separation channel 2 and the electrophoretic separation process can proceed as usual (e.g. to the right in the orientation shown in FIG. 10).

In the arrangement shown in FIG. 10 the separation channel 2 is split into two separate parts, each part leading respectively to the first and second surfaces 14 and 15. However, this is not essential. In other embodiments the separation channel 2 may be continuous, with the first and second surfaces 14 and 15 being directly adjacent to each other. An example of such an arrangement is shown in FIG. 11.

Embodiments are capable of handling samples in the nanolitre to picolitre ranges or lower for example. Using plural, parallel electrophoresis channels allows multiple samples (droplets) to be tested simultaneously (e.g. 10 or more, or 100 or more). The separation can be performed quickly (for example in less than 10 seconds, less than one minute, or less than 10 minutes). Additionally or alternatively the approach allows substantially the entire sample from each single droplet to be is processed in the separation channel 2. Thus, high throughput, quantitative separation can be achieved.

FIG. 12 is a microscopic photographic top view of an example configuration for the sample reservoirs 44 and indentations 48 in the second substrate 42. FIG. 13 is a microscopic top view of an example configuration for the indentations 46 in the first substrate 40 compatible with the arrangement of FIG. 12.

FIGS. 14A-C are microscopic photographic tops views of sample moving through an apparatus 1 comprising multiple instances of the reservoirs and indentations shown in FIGS. 12 and 13. In FIG. 14A, the reservoirs and indentations 44 and 48 are shown filled with a liquid sample. FIG. 14B shows the apparatus after relative sliding (“slipping”) of the first and second substrates into the “first position” (as in FIG. 9) generating droplets 6 in the indentations 46. FIG. 14C shows the portion of the apparatus 1 containing the droplets 6 after further relative movement between the first and second substrates brings them into the “second position” and the droplets 6 into respective injection positions (as in FIG. 10 or 11).

FIG. 15 shows microscopic photographic top views of the separation channels 2 of the apparatus 1 of FIGS. 14A-C after injection of the droplets 6 into separation channels (as shown in FIG. 14C). At Os the droplets 6 are localized and stable at the injection position prior to application of the electric field. At is the electric field has been applied and the droplets 6 have ruptured and started to move through the separation channel 2. At 3 s the droplets can be seen to have moved further and by 10 s separation into individual components has occurred.

FIG. 16 depicts example electropherograms of five different fluorescent molecules separated in an apparatus 1 of the type shown in FIGS. 12-15. The lower sub-figure shows the corresponding pseudo gel plot for each result. Experimental conditions were as follows:

Molecules Separated: Eosin Y, Fluorescein 5(6)-Isothiocyanate (FITC) isomer 1 and 2, Fluorescein, 5-carboxyFluorescein;

Separation Field Strength: 90 V/cm;

Separation medium: PEO gel (e.g. 2% w./w. PEO in TBE buffer)

Detection Point: 3.5 cm.

FIG. 17: depicts example electropherograms of three different fluorescent molecules separated in an apparatus 1 of the type shown in FIGS. 12-15. The lower sub-figure shows the corresponding pseudo gel plot for each result. Experimental conditions were as follows:

Molecules Separated: Fluorescein 5(6)-Isothiocyanate (FITC), Fluorescein, 5-carboxyFluorescein;

Separation Field Strength: 80 V/cm;

Separation medium: Agrose gel. (4% Agrose)

Detection Point: 1 cm.

FIGS. 18 and 19 show a quantitative calibration of concentrations using six different separation channels 2A-2F, each separation channel containing a different concentration of sample. FIGS. 18A and 18B depict electropherogram results for the six channels 2A-2F. In this example, the peaks “a” correspond to 5-Carfluorescein (5-carbfl), the peaks “b” to Fluorescein (FL), and the peaks “c” to FITC. The concentration of 5-carbfl in each of the separations channels was 25 μM. The concentration of FL in each of the channels was 250 μM. The concentration of FITC was 0, 50, 150, 200 and 250 μM respectively for the six separation channels 2A-2F. FIG. 19 depicts a plot of peak area against concentration of FITC, showing a straight line relationship that can be used for calibration of FITC concentrations.

### VARIATION ON SECOND EXEMPLARY EMBODIMENT

In the second exemplary embodiment described above, sample droplets 6 are formed which comprise a membrane 5 that isolates a sample from the surrounding environment. The membrane 5 is such that the sample droplet 6 can be brought to an injection position in contact with a transport medium 3 defining a separation channel 2 without the sample entering the transport medium 3 until an electric field is applied that ruptures the droplet. The membrane 5 may be formed using a surfactant for example. However, it is not essential to provide the membrane 5. The sample droplets 6 can be formed without using a surfactant and/or in such a way that the sample enters the transport medium 3 at the injection position even without the application of an electric field. In such an embodiment, the electric field for carrying out the electrophoretic separation should nevertheless be applied as soon as possible after the sample droplet 6 reaches the injection position to prevent spreading out of the sample by molecular diffusion before the electrophoretic process has been started.

The apparatus and methodology depicted and explained above with reference to FIGS. 7-11 can be used to implement such an embodiment, with the only difference being that the membrane 5 is either not present or not sufficient to prevent the sample entering the transport medium 3 at the injection position even in the absence of an applied electric field. Thus, an apparatus for introducing a sample into a separation channel for electrophoresis may be provided that comprises a separation channel 2 having a transport medium 3. A conveyance unit (comprising first and second substrates 40 and 42) may be provided for bringing a sample droplet 6 to an injection position in which the sample droplet is in contact with the transport medium 3 of the separation channel 2. An electrophoresis driving unit may be provided that is configured to apply an electric field to the sample droplet 6 via the transport medium 3. The first and second substrates 40 and 42 may be slidably engagable against one another and configured such that the sample droplet 6 can be formed between opposing faces thereof when the first and second substrates 40 and 42 are thus engaged. The first and second substrates 40 and 42 may be configured such that the sample droplet 6 can be brought to the injection position by sliding the first and second substrates relative to each other from a first position to a second position.

1. A method of introducing a sample into a separation channel for electrophoresis, comprising:
encapsulating the sample within a sample droplet, the sample droplet having a spatially continuous sample droplet membrane that surrounds the sample within the sample droplet;
bringing the sample droplet to an injection position in which a first region of the sample droplet membrane is in contact with a portion of a first surface and a second region of the sample droplet membrane, different from the first region, is in contact with a portion of a second surface, wherein:
the first and second surfaces are configured so that the material forming the sample droplet membrane will not pass through the surfaces and is capable of stably isolating the sample from the first and second surfaces while the droplet is intact;
the method further comprises applying an electric field to the sample droplet via the first and second surfaces, the electric field being such as to cause the sample droplet membrane to rupture and the sample to be brought into contact with the first and second surfaces; and
the second surface is a surface of a transport medium defining the separation channel, the transport medium being configured such that the sample passes through the second surface and into the separation channel when the sample droplet membrane is ruptured.

2. A method according to claim 1, wherein the first surface is also a surface of a transport medium.

3. A method according to claim 1, wherein the sample droplet membrane comprises a surfactant.

4. A method according to claim 1, wherein the sample comprises an aqueous solution and the second surface is hydrophilic.

5. A method according to claim 4, wherein the first surface is also hydrophilic.

6. A method according to claim 4, wherein the sample droplet membrane comprises amphiphilic molecules.

7. A method according to claim 1, wherein the sample comprises hydrophobic material and the first surface is also hydrophobic.

8. A method according to claim 1, wherein the first and second surfaces are electrically isolated from each other in the absence of any sample droplet connecting any portion of the first and second surfaces together.

9. A method according to claim 1, wherein the first and second surfaces define opposite surfaces of an elongate channel and the sample droplet is brought to the injection position by conveying the sample droplet along the elongate channel.

10. A method according to claim 9, wherein a stream comprising a plurality of the sample droplets is conveyed into the elongate channel.

11. A method according to claim 10, wherein one or more reference droplets are provided in between adjacent sample droplets in the stream to provide calibration references.

12. A method according to claim 10, wherein an electric field is applied that extends at least from the first surface through the second surface to a distal region within the transport medium, the electrical field causing simultaneous rupture of the sample droplet membranes of a plurality of sample droplets in the elongate channel, the samples from the ruptured droplets passing through the second surface and undergoing electrophoresis in parallel directions within the transport medium between the second surface and the distal region.

13. A method according to claim 9, wherein the transport medium defining the second surface is a gel.

14. A method according to claim 13, wherein the first surface is also a surface of a gel.

15. A method according to claim 1, wherein:
the sample droplet is formed in between opposing faces of first and second substrates that are slidably engaged against one another; and
the sample droplet is brought to the injection position by sliding the first and second substrates relative to each other from a first position to a second position.

16. A method according to claim 15, wherein the sample droplet is formed by:
introducing a liquid sample to one or more reservoirs formed in one or both of the first and second substrates; and
positioning the first and second substrates such that an indentation in the first substrate for holding the droplet when the first and second substrates are in the first position overlaps with an indentation in the second substrate that on its own or in combination with other indentations in either or both of the first and second substrates, provides a continuous flow path to one or more of the reservoirs.

17. A method according to claim 15, wherein:
when the first and second substrates are in the first position, the droplet is contained with a closed cavity formed by an indentation within the first substrate and an opposing surface of the second substrate.

18. A method according to claim 17, wherein:
when the first and second substrates are in the second position, the indentation within the first substrate containing the droplet is brought into a position that is opposite to an opening in the second substrate that provides access to the second surface, the transport medium defining the separation channel being formed within the second substrate.

19. An apparatus for introducing a sample into a separation channel for electrophoresis, comprising:
the separation channel, wherein the separation channel comprises a transport medium;
a conveyance unit configured to bring a sample encapsulated within a sample droplet, the sample droplet having a spatially continuous sample droplet membrane that surrounds the sample within the sample droplet, to an injection position in which a first region of the sample droplet membrane is in contact with a portion of a first surface and a second region of the sample droplet membrane, different from the first region, is in contact with a portion of a second surface, wherein:
the first and second surfaces are configured so that the material forming the sample droplet membrane will not pass through the surfaces and is capable of stably isolating the sample from the first and second surfaces while the droplet is intact;
the apparatus further comprises an electrophoresis driving unit configured to apply an electric field to the sample droplet via the first and second surfaces, the electric field being such as to cause the sample droplet membrane to rupture and the sample to be brought into contact with the first and second surfaces; and
the second surface is a surface of the transport medium of the separation channel, the transport medium being configured such that the sample passes through the second surface and into the separation channel when the sample droplet membrane is ruptured.

20-34. (canceled)

35. A method of introducing a sample into a separation channel for electrophoresis, comprising:
forming a sample droplet between first and second substrates that are slidably engaged against one another;
bringing the sample droplet to an injection position in which the sample droplet is in contact with a transport medium in the separation channel by sliding the first and second substrates relative to each other from a first position to a second position; and
applying an electric field to the sample droplet via the transport medium.

36. A method according to claim 35, wherein the sample droplet is formed by:
introducing a liquid sample to one or more reservoirs formed in one or both of the first and second substrates; and
positioning the first and second substrates such that an indentation in the first substrate for holding the droplet when the first and second substrates are in the first position overlaps with an indentation in the second substrate that on its own or in combination with other indentations in either or both of the first and second substrates, provides a continuous flow path to one or more of the reservoirs.

37. A method according to claim 35, wherein:
when the first and second substrates are in the first position, the droplet is contained within a closed cavity formed by an indentation within the first substrate and an opposing surface of the second substrate.

38. A method according to claim 37, wherein:
when the first and second substrates are in the second position, the indentation within the first substrate containing the droplet is brought into a position that is opposite to an opening in the second substrate that provides access to the transport medium, the transport medium being formed within the second substrate.

39. An apparatus for introducing a sample into a separation channel for electrophoresis, comprising:
the separation channel, wherein the separation channel comprises a transport medium;
a conveyance unit configured to bring a sample droplet to an injection position in which the sample droplet is in contact with the transport medium of the separation channel;
an electrophoresis driving unit configured to apply an electric field to the sample droplet via the transport medium; and
first and second substrates that are slidably engagable against one another and configured such that the sample droplet can be formed between opposing faces thereof when the first and second substrates are thus engaged, wherein
the first and second substrates are configured such that the sample droplet can be brought to the injection position by sliding the first and second substrates relative to each other from a first position to a second position.

40-44. (canceled)
